(19) United States
(12) Patent Application Publication
(10) Pub. No.: US 2026/0241706 A1
(43) Pub. Date: Aug. 20, 2026

(54) PRINTER APPARATUS, CONTROL METHOD, AND COMPUTER-READABLE MEDIUM

(71) Applicant: Noriaki Aoki, Sunto Shizuoka (JP)

(72) Inventor: Noriaki Aoki, Sunto Shizuoka (JP)

(73) Assignee: ETRIA CO., LTD., Kanagawa (JP)

(21) Appl. No.: 19/281,629

(22) Filed: Jul. 26, 2025

(30) Foreign Application Priority Data
Feb. 20, 2025 (JP) 2025-025830

(51) Int. Cl. B41J 2/355; B41J 2/365; B41J 15/04

(52) U.S. Cl. CPC B41J 2/3558; B41J 2/365; B41J 15/04

(57) ABSTRACT

A printer apparatus is configured to perform printing on a sheet-shaped medium with a thermal head including a plurality of heating elements. The apparatus includes an adjuster configured to perform adjustment to bring an amount of heat generated by the plurality of heating elements closer to a defined value in response to a drop in a drive voltage of the thermal head.

### CROSS-REFERENCE TO RELATED APPLICATIONS

The present application claims priority under 35 U.S.C. § 119 to Japanese Patent Application No. 2025-025830, filed on Feb. 20, 2025. The contents of which are incorporated herein by reference in their entirety.

### BACKGROUND

### Technical Field

Embodiments described herein relate to a printer apparatus, a control method, and a computer-readable medium.

### Related Art

In a printer apparatus that performs printing with a thermal head, it is necessary to simultaneously heat a large number of heating elements, for printing with high density, such as printing of a ruled line extending in a width direction of a print medium or solid black. This situation requires much power to drive the thermal head.

However, when a load current supplied to the thermal head increases, a drive voltage of the thermal head or a stepping motor that conveys the print medium may drop. In this case, insufficient heating of the heating elements or loss of synchronization due to a decrease in driving torque of the stepping motor may cause impaired print quality.

### BRIEF DESCRIPTION OF THE DRAWINGS

FIG. 1 is a perspective view illustrating an example of an external appearance of a printer apparatus;

FIG. 2 is a perspective view illustrating an example of an internal structure of the printer apparatus;

FIG. 3 is a block diagram illustrating an example of a configuration of the printer apparatus;

FIG. 4 is a block diagram illustrating an example of flows of power supply and signals in the printer apparatus;

FIG. 5 is a block diagram illustrating an example of a functional configuration of a control unit;

FIG. 6 is a diagram illustrating an example of setting information; and

FIG. 7 is a flowchart illustrating an example of a procedure of a process executed by the control unit.

### DETAILED DESCRIPTION

A printer apparatus according to an embodiment is configured to perform printing on a sheet-shaped medium with a thermal head including a plurality of heating elements. The apparatus including an adjuster configured to perform adjustment to bring an amount of heat generated by the plurality of heating elements closer to a defined value in response to a drop in a drive voltage of the thermal head.

An embodiment may provide a printer apparatus, a control method, and a computer-readable medium that enable maintaining print quality even when a drive voltage of a thermal head or a stepping motor drops.

### First Embodiment

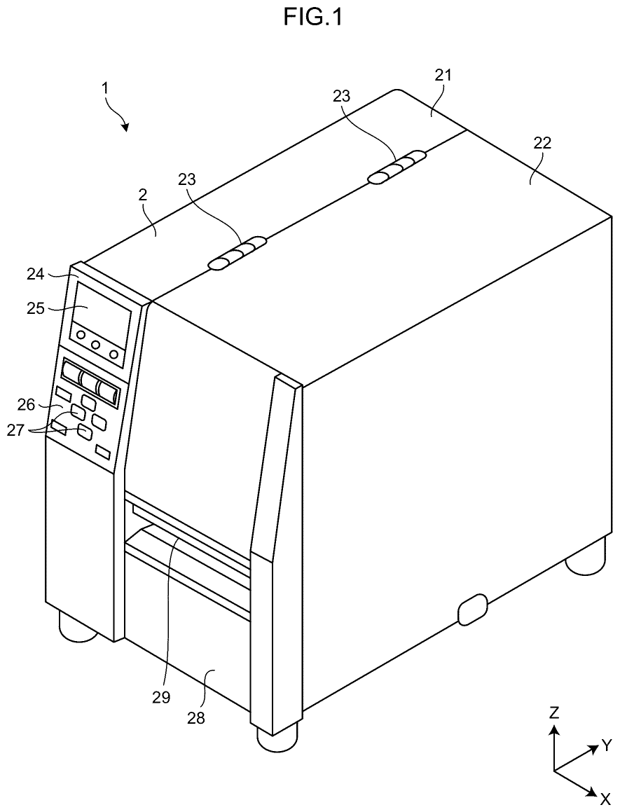

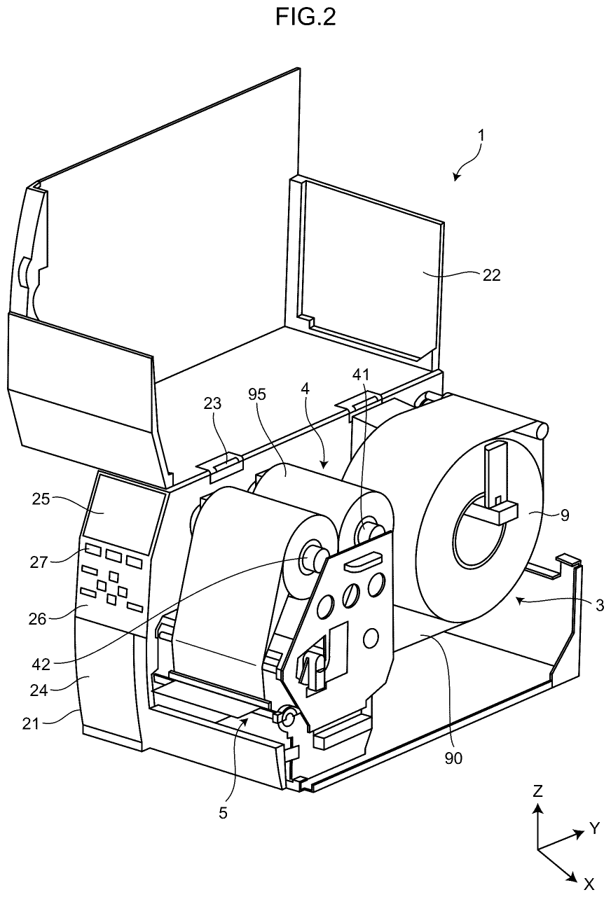

An embodiment will be described with reference to the drawings. FIG. 1 is a perspective view illustrating an example of an external appearance of a printer apparatus 1. FIG. 2 is a perspective view illustrating an example of an internal structure of the printer apparatus 1. In the drawings, a three-dimensional coordinate system is also illustrated for convenience of description. In the three-dimensional coordinate system, a width direction (left-right direction) of the printer apparatus 1 is an X-axis direction, a depth direction (front-rear direction) is a Y-axis direction, and a height direction (up-down direction) is a Z-axis direction. The three axes of the X axis, the Y axis, and the Z axis are orthogonal to each other.

The printer apparatus 1 issues a sheet-shaped medium (e.g., paper sheet) after printing information thereon. The printer apparatus 1 includes a casing 2 that is divided into left and right portions, and includes a first case 21 and a second case 22. The first case 21 and the second case 22 are connected by a hinge portion 23.

The hinge portion 23 connects an end of a top surface of the first case 21 and an end of a top surface of the second case 22. Therefore, the second case 22 is turnable about the hinge portion 23 relative to the first case 21, and functions as a lid to open and close the casing 2.

With the rotation, the second case 22 moves between a closed position (see FIG. 1) where the casing 2 is closed and an opened position (see FIG. 2) where the casing 2 is opened. The opened position is located above the first case 21, and when the second case 22 is located at the opened position, the top surface of the second case 22 faces the top surface of the first case 21.

The first case 21 has a front surface portion constituted by a front panel 24 that is provided with a display unit 25 and an operation unit 26. The display unit 25 includes, for example, a liquid crystal display with backlight, but another type of display device may be used. The operation unit 26 includes a plurality of operation buttons 27. The operation buttons 27 receive operations by an operator.

The second case 22 has a front surface portion constituted by a front panel 28 that is provided with a paper exit 29. The paper exit 29 is an opening from which a printed paper sheet is ejected.

The printer apparatus 1 includes a paper housing portion 3, a ribbon holding portion 4, a printing unit 5, and the like inside the casing 2.

The paper housing portion 3 stores a paper roll 9 so as to enable drawing out of a paper sheet 90. The paper roll 9 is formed by rolling up the paper sheet 90 having a strip shape. The paper sheet 90 may be a label (label sheet) of predetermined size that is stuck on a strip-shaped backing sheet, or a strip-shaped label (label without the backing sheet), in addition to the strip-shaped sheet. The label is a sheet whose one surface is provided with a sticky adhesive layer. The sheet may be made of paper or resin film.

The ribbon holding portion 4 includes a supply spindle 41 and a rewinding spindle 42, and holds an ink ribbon 95. The ink ribbon 95 with a strip shape includes a wound portion before being supplied, the wound portion being supported by the supply spindle 41, and a portion after passing through the printing unit 5, the portion being rewound by the rewinding spindle 42.

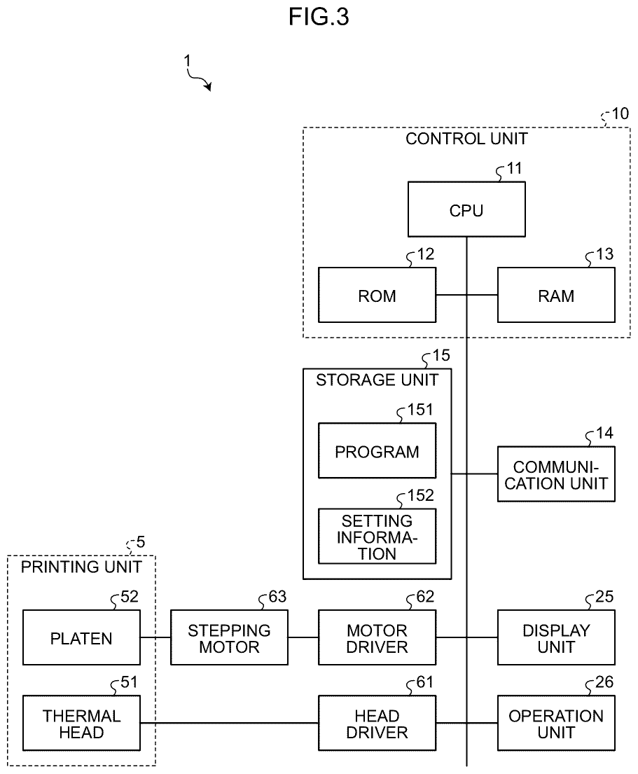

FIG. 3 is a block diagram illustrating an example of a configuration of the printer apparatus 1. The printing unit 5 includes a thermal head 51 and a platen 52, and performs printing on the sheet-shaped medium (e.g., paper sheet 90). The thermal head 51 is a line thermal head including a plurality of heating elements. The platen 52 is, for example, a roller whose surface is made of an elastic material, and rotates by a driving force of a stepping motor.

The ink ribbon 95 is held between the thermal head 51 and the platen 52, together with the paper sheet 90. The paper sheet 90 and the ink ribbon 95 are conveyed by the rotation of the platen 52.

Each of the heating elements of the thermal head 51 heat and melt ink applied to the ink ribbon 95. The melted ink is transferred to the paper sheet 90. Therefore, printing is performed on the paper sheet 90. The paper sheet 90 that has passed through the printing unit 5 is ejected from the paper exit 29.

Here, the printer apparatus 1 illustrated in FIGS. 1 and 2 is merely an example, and in implementation, the printer apparatus may have different appearances and sizes, and for example, may be a printer apparatus designed to have a size and a shape suitable for portable use.

The printer apparatus 1 further includes a central processing unit (CPU) 11, a read only memory (ROM) 12, a random access memory (RAM) 13, a communication unit 14, a storage unit 15, a head driver 61, a motor driver 62, a stepping motor 63, and the like. These are housed in the first case 21.

The CPU 11 is an example of a processor, and integrally controls the units of the printer apparatus 1. The ROM 12 stores various programs. The RAM 13 is a workspace into which programs and various data are loaded.

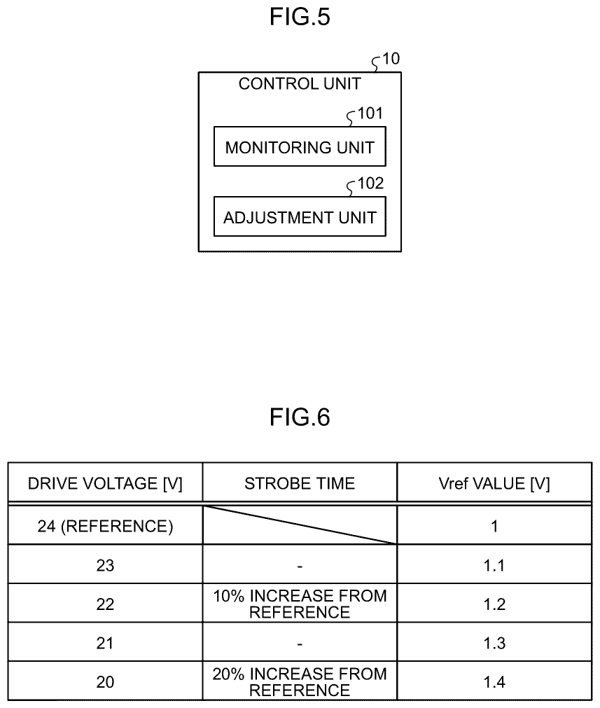

The CPU 11, the ROM 12, and the RAM 13 constitute a control unit 10. In the control unit 10, the CPU 11 loads programs stored in the ROM 12 and the storage unit 15 into the RAM 13 for execution to implement various functional units for operating the printer apparatus 1. In other words, the control unit 10 functions as the various functional units which will be described later with reference to FIG. 5.

The communication unit 14 is a communication interface connectable to a network. The communication unit 14 communicates with an external device via the network to acquire, for example, data to be printed.

The storage unit 15 includes a storage medium such as a solid state drive (SSD) or a flash memory, and maintains stored contents even when power is turned off. The storage unit 15 stores a program 151 and various setting information 152 that are enabled by the CPU 11.

The head driver 61 controls the thermal head 51. The head driver 61 outputs, for example, a strobe (STB) signal. The heating elements of the thermal head 51 is energized and driven at timing indicated by the STB signal. The energization time (hereinafter referred to as a strobe time) for each of the heating elements is determined by a pulse width of the STB signal. Printing has a density that is changeable according to the strobe time, whereby enabling adjustment or the like of the quality.

The motor driver 62 controls the stepping motor 63. The stepping motor 63 generates the driving force for conveying the paper sheet 90. The rotation of the stepping motor 63 is transmitted to the platen 52 via a gear.

The motor driver 62 energizes the stepping motor 63 according to a reference voltage value (Vref value). An initial value of the Vref value is set so that a current having a defined value is supplied to the stepping motor 63 on the premise that the stepping motor 63 is driven at a rated voltage (or a voltage within a range acceptable in a specification). The defined value is a value with which the driving torque necessary for conveying the paper sheet 90 can be obtained by the stepping motor 63.

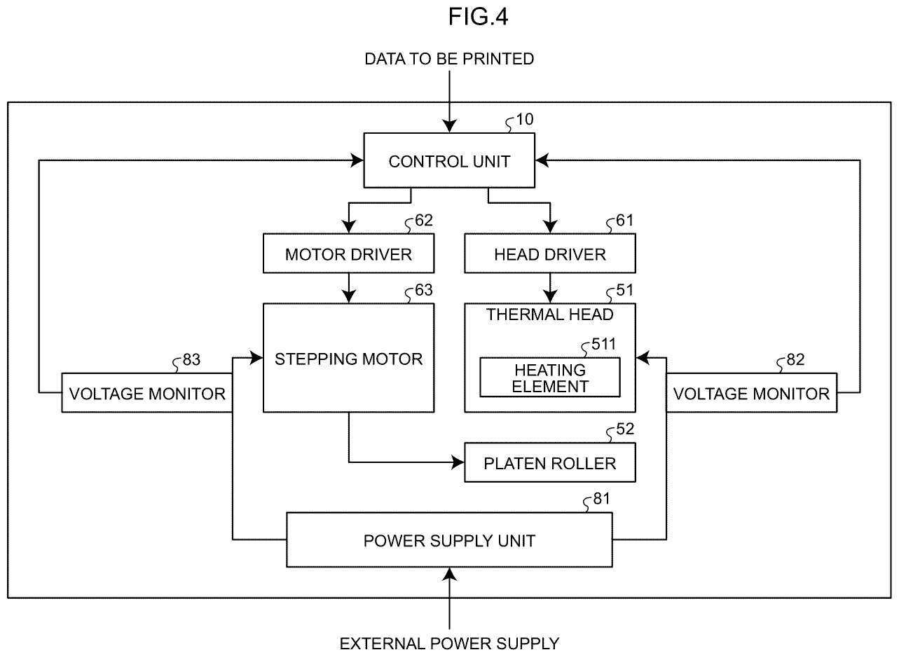

FIG. 4 is a block diagram illustrating an example of flows of power supply and signals in the printer apparatus 1. The printer apparatus 1 further includes a power supply unit 81, voltage monitors 82 and 83, and the like.

The power supply unit 81 receives power supplied from an external power supply, and supplies the received power to the units of the printer apparatus 1. In the implementation, the printer apparatus 1 may include a secondary battery or a charging circuit, and the external power supply may be connected via an AC adapter.

Power supplied from the power supply unit 81 to the thermal head 51 and the stepping motor 63 has a voltage value that is basically set to a predetermined value (e.g., 24 (V)). The predetermined value is, for example, a rated value defined in the specification.

However, the voltage value of power actually supplied by the power supply unit 81 varies from the predetermined value, depending on an operation condition of each of the units in the printer apparatus 1.

When the variation of the voltage value is out of the range acceptable in the specification of the thermal head 51 or the stepping motor 63, for example, inappropriate control of heating of a heating element 511 or the loss of synchronization of the stepping motor 63 may occur, causing a failure such as deterioration of the print quality.

Specifically, when the voltage (drive voltage) of power actually supplied to the thermal head 51 is lower than 24 (V) although the thermal head 51 is operating on the premise of supply of a voltage of 24 (V), the heating element 511 may be insufficiently heated, causing light printing.

Similarly, when the voltage (drive voltage) of power actually supplied to the stepping motor 63 is lower than 24 (V) although the stepping motor 63 is operating on the premise of supply of a voltage of 24 (V), a current necessary to obtain the driving torque is not supplied, causing the loss of synchronization. In this case, there is a disadvantage that, for example, conveyance of the paper sheet 90 is behind schedule.

The drop in drive voltage as described above occurs due to an increase in load current supplied to the thermal head 51, for example, when many heating elements 511 are simultaneously heated such as for printing a ruled line in a width direction of the paper sheet 90.

Therefore, the printer apparatus 1 of the present embodiment monitors variation in voltage (drive voltage) applied to the thermal head 51 or the stepping motor 63 with the voltage monitors 82 and 83, and performs, when the drop in drive voltage is detected, drive control according to the drop in voltage.

The voltage monitor 82 outputs a value that varies according to the drive voltage of the thermal head 51. In addition, the voltage monitor 83 outputs a value that varies according to the drive voltage of the stepping motor 63. Outputs of the voltage monitors 82 and 83 are input to the control unit 10.

Here, each of the values output from the voltage monitors 82 and 83 may be, for example, the voltage value itself or may indicate a level or the like corresponding to the voltage value. Alternatively, the control unit 10 may determine the voltage value, the level corresponding to the voltage value, or the like on the basis of the value output from each of the voltage monitors 82 and 83.

FIG. 5 is a block diagram illustrating an example of a functional configuration of the control unit 10. The control unit 10 functions as a monitoring unit 101, an adjustment unit (adjuster) 102, or the like when the CPU 11 executes a program. In other words, the control unit 10 includes various functional units such as the monitoring unit 101, the adjustment unit 102, and the like.

The monitoring unit 101 monitors voltages applied to the thermal head 51 and the stepping motor 63.

Upon the drive voltage of the thermal head 51 drops, the adjustment unit 102 adjusts the amount of heat generated by the heating element 511 to be closer to a defined value.

In addition, when the drive voltage of the stepping motor 63 drops, the adjustment unit 102 adjusts a drive current of the stepping motor 63 to be closer to a defined value. More specifically, for example, the adjustment is performed as follows.

The control unit 10 monitors, as the monitoring unit 101, the variation in the voltage applied to the thermal head 51 on the basis of the output of the voltage monitor 82, and performs control, as the adjustment unit 102, according to the drop when detecting the drop in the voltage. This control is, for example, control for increase of the strobe time, and is performed on the head driver 61.

In addition, the control unit 10 monitors, as the monitoring unit 101, the variation in the voltage applied to the stepping motor 63 on the basis of the output of the voltage monitor 83, and performs control, as the adjustment unit 102, according to the drop when detecting the drop in the voltage. This control is, for example, control for increase of the Vref value, and is performed on the motor driver 62.

FIG. 6 is a diagram illustrating an example of the setting information 152. The setting information 152 is, for example, information in which a plurality of values of drive voltage are associated with information about degrees of increase in strobe time suitable for the plurality of values. Furthermore, the setting information 152 is information in which the values of the plurality of drive voltages are associated with Vref values suitable for the values.

The monitoring unit 101 and the adjustment unit 102 each refer to the setting information 152 to acquire a setting value used for processing.

The monitoring unit 101 increases the strobe time by a predetermined value (e.g., 10%) every time the voltage applied to the thermal head 51 decreases from the reference value (e.g., 24 (V)) by a predetermined value (e.g., 2 (V)).

In addition, the monitoring unit 101 increases the Vref value by a predetermined value (e.g., 0.1 (V)) every time the voltage applied to the stepping motor 63 decreases by a predetermined value (e.g., 1 (V)) from the reference value (e.g., 24 (V)).

Referring to the setting information 152 enables the monitoring unit 101 to acquire a set value corresponding to a voltage value each time and reflect the setting value.

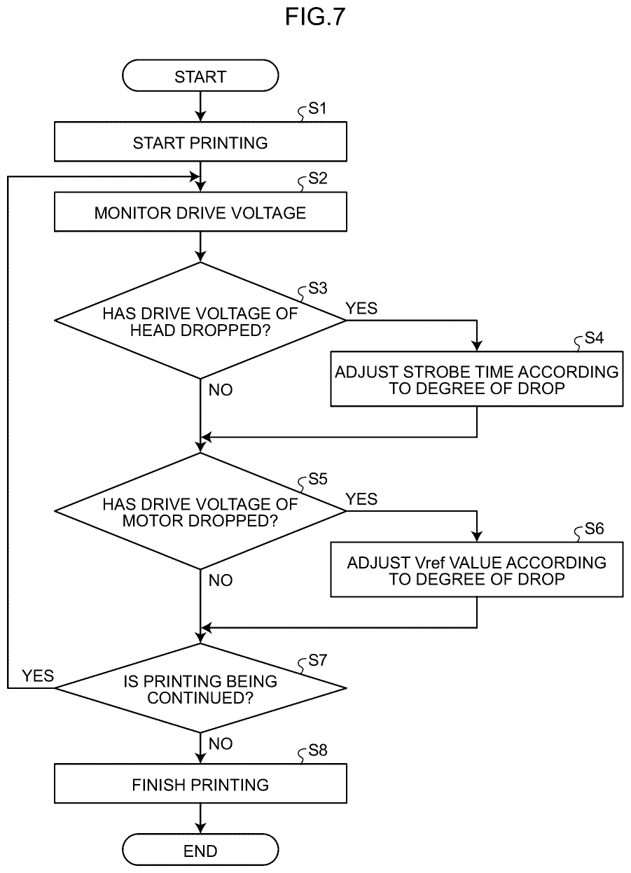

FIG. 7 is a flowchart illustrating an example of a procedure of a process executed by the control unit 10. As a printing process starts (Step S1), the control unit 10 monitors the drive voltage, as the monitoring unit 101 (Step S2). In other words, the control unit 10 monitors the voltage values applied to the thermal head 51 and the stepping motor 63, on the basis of the outputs of the voltage monitors 82 and 83.

When it is determined that the drive voltage of the thermal head 51 drops (Step S3_Yes), the control unit 10 adjusts the strobe time according to a degree of drop in voltage, as the adjustment unit 102 (Step S4). In other word, for example, when the voltage actually applied to the thermal head 51 is 22 (V) although driving should be performed at 24 (V), the control unit 10 adjusts the strobe time to be longer by 10%. Then, the control unit 10 proceeds to Step S5.

When it is determined that the drive voltage of the thermal head 51 does not drops (Step S3_No), the control unit 10 skips Step S4 and proceeds to Step S5.

When it is determined that the drive voltage of the stepping motor 63 drops (Step S5_Yes), the control unit 10 adjusts the Vref value according to the degree of drop in voltage, as the adjustment unit 102 (Step S6). In other word, for example, when the voltage actually applied to the stepping motor 63 is 23 (V) although driving should be performed at 24 (V), the control unit 10 changes the Vref value from 1 (V) to 1.1 (V). Then, the control unit 10 proceeds to Step S7.

When it is determined that the drive voltage of the stepping motor 63 does not drops (Step S5_No), the control unit 10 skips Step S6 and proceeds to Step S7.

Next, the control unit 10 determines whether the printing process is being continued (Step S7), returns the process to Step S2 to continue the monitoring of the drive voltage (Step S7_Yes) when the printing process is being continued, and otherwise (Step S7_No), finishes the printing process (Step S8).

In the printer apparatus 1 configured as described above, when the voltage applied to the thermal head 51 drops due to, for example, performance of the printing process having a high dot density on the basis of the data to be printed including a horizontal ruled line, a black solid, or the like, the strobe time is set longer than a usual strobe time. Note that the normal strobe time is a strobe time when there is no problem in the voltage value.

Therefore, even when the voltage applied to the thermal head 51 is low and results in insufficient heating of the heating element 511 with the normal strobe time, the heating element 511 is energized for a longer strobe time, and thus, enabling a sufficient amount of heat generated.

Furthermore, in the printer apparatus 1, when the voltage applied to the stepping motor 63 has dropped, the Vref value is set to a value higher than usual.

Therefore, when the voltage applied to the stepping motor 63 decreases due to the influence or the like of the increase in the load current on the thermal head 51 and the insufficient current for driving is obtained, the current value can be increased to avoid the loss of synchronization.

As described above, according to the present embodiment, even when the drive voltage of the thermal head 51 or the stepping motor 63 drops due to performance of the printing with high density or the like, generation of sufficient heat of the heating element 511 and avoidance of the loss of synchronization of the stepping motor 63 enables normal operation of the printer apparatus 1. Therefore, according to the present embodiment, it is possible to suppress deterioration in print quality due to the drop in drive voltage of the thermal head 51 or the stepping motor 63 and maintain good print quality.

The embodiment described above can be implemented by being appropriately modified by partially changing the configuration or function of each of the above devices. Therefore, in the following, some modifications according to the embodiment described above will be described as other embodiments. Note that, in the following, points different from the embodiment described above will be mainly described, points common to the contents having been already described are denoted by the same reference numerals without detailed description thereof. In addition, the modifications described below may be implemented individually, or may be appropriately implemented in combination.

### Second Embodiment

In the present embodiment, the control unit 10 further functions as a prediction unit (predictor). When receiving the data to be printed, the control unit 10 as the prediction unit predicts the drop in voltage on the basis of the data to be printed, before performing the printing process. Specifically, for example, when the data to be printed has a portion requiring heating of a large number of the heating elements 511 at the same time, such as a ruled line in the width direction of the paper sheet 90, the control unit 10 predicts that the drop in voltage may occur at the portion.

When predicting the drop in voltage on the basis of the data to be printed, as the prediction unit, the control unit 10 of the present embodiment performs adjustment following the previous embodiment, that is, adjustment to increase the strobe time or increase the Vref value.

According to the present embodiment described above, it is possible to prevent the drop in voltage in advance that is predicted from a time point before printing. Therefore, according to the present embodiment, the possibility of improving the print quality can be increased even in the first printed material.

The program executed by each device of the embodiments described above is provided by being incorporated in advance in the ROM or the like. The program executed by each device of the embodiments described above may be provided by being recorded in the form of installable or executable file, on a computer-readable recording medium, such as a CD-ROM, a flexible disk (FD), a CD-R, or a digital versatile disk (DVD).

Furthermore, the program executed by each device of the embodiments described above may be configured to be stored on a computer connected to a network such as the Internet and provided by being downloaded via the network. In addition, the program executed by each device of the embodiments described above may be configured to be provided or distributed via a network such as the Internet.

The above embodiments are specific examples of the technical idea shown in the following Supplementary Notes 1 to 20.

### Supplementary Note 1

A printer apparatus configured to perform printing on a sheet-shaped medium with a thermal head including a plurality of heating elements, the apparatus including
an adjustment unit configured to perform adjustment to bring an amount of heat generated by the plurality of heating elements closer to a defined value in response to a drop in a drive voltage of the thermal head.

### Supplementary Note 2

The printer apparatus according to Supplementary Note 1, in which
the adjustment unit is configured to perform adjustment to increase a strobe time defining an energization time for the plurality of heating elements to bring the amount of heat generated by the plurality of heating elements closer to the defined value.

### Supplementary Note 3

The printer apparatus according to Supplementary Note 1, in which
the adjustment unit is configured to, in response to a drop in a drive voltage of a stepping motor configured to convey the medium, adjust a drive current of the stepping motor to be closer to a defined value.

### Supplementary Note 4

The printer apparatus according to Supplementary Note 3, in which
the adjustment unit is configured to perform adjustment to increase a Vref value of a motor driver configured to control the stepping motor to bring the drive current of the stepping motor closer to the defined value.

### Supplementary Note 5

The printer apparatus according to any one of Supplementary Notes 1 to 4, further including a prediction unit configured to predict a drop in a drive voltage of the thermal head before performing printing, based on data to be printed used to drive the thermal head, in which
the adjustment unit is configured to perform adjustment to bring the amount of heat generated by the plurality of heating elements closer to the defined value in a case where the prediction unit predicts a drop in the drive voltage of the thermal head.

### Supplementary Note 6

The printer apparatus according to Supplementary Note 2, in which
the adjustment unit is configured to adjust the strobe time according to setting information in which a plurality of values of the drive voltage are associated with information about degrees of increase in the strobe time suitable for the plurality of values.

### Supplementary Note 7

The printer apparatus according to Supplementary Note 4, in which
the adjustment unit is configured to adjust the Vref value according to setting information in which a plurality of values of the drive voltage and the Vref value suitable for the plurality of values are associated with each other.

### Supplementary Note 8

A control method for a printer apparatus configured to perform printing on a sheet-shaped medium with a thermal head including a plurality of heating elements, the method including
a step of performing adjustment to bring an amount of heat generated by the plurality of heating elements closer to a defined value in response to a drop in a drive voltage of the thermal head.

### Supplementary Note 9

The control method according to Supplementary Note 8, in which
adjustment to increase a strobe time defining an energization time for the plurality of heating elements is performed to bring the amount of heat generated by the plurality of heating elements closer to the defined value.

### Supplementary Note 10

The control method according to Supplementary Note 8, in which
in response to a drop in a drive voltage of a stepping motor configured to convey the medium, a drive current of the stepping motor is adjusted to be closer to a defined value.

### Supplementary Note 11

The control method according to Supplementary Note 10, in which
adjustment to increase a Vref value of a motor driver configured to control the stepping motor is performed to bring the drive current of the stepping motor closer to the defined value.

### Supplementary Note 12

The control method according to any one of Supplementary Notes 8 to 11, further including a step of predicting a drop in a drive voltage of the thermal head before performing printing, based on data to be printed used to drive the thermal head, wherein
adjustment to bring the amount of heat generated by the plurality of heating elements closer to the defined value is performed in a case where a drop in the drive voltage of the thermal head is predicted.

### Supplementary Note 13

The control method according to Supplementary Note 9, in which
the strobe time is adjusted according to setting information in which a plurality of values of the drive voltage are associated with information about degrees of increase in the strobe time suitable for the plurality of values.

### Supplementary Note 14

The control method according to Supplementary Note 11, in which
the Vref value is adjusted according to setting information in which a plurality of values of the drive voltage and the Vref value suitable for the plurality of values are associated with each other.

### Supplementary Note 15

A program for causing a computer included in a printer apparatus performing printing on a sheet-shaped medium with a thermal head including a plurality of heating elements to function as
an adjustment unit configured to perform adjustment to bring an amount of heat generated by the plurality of heating elements closer to a defined value in response to a drop in a drive voltage of the thermal head.

### Supplementary Note 16

The program according to Supplementary Note 15, in which
the adjustment unit is configured to perform adjustment to increase a strobe time defining an energization time for the plurality of heating elements to bring the amount of heat generated by the plurality of heating elements closer to the defined value.

### Supplementary Note 17

The program according to Supplementary Note 15, in which
the adjustment unit is configured to, in response to a drop in a drive voltage of a stepping motor configured to convey the medium, adjust a drive current of the stepping motor to be closer to a defined value.

### Supplementary Note 18

The program according to Supplementary Note 17, in which
the adjustment unit is configured to perform adjustment to increase a Vref value of a motor driver configured to control the stepping motor to bring the drive current of the stepping motor closer to the defined value.

### Supplementary Note 19

The program according to any one of Supplementary Notes 15 to 18, further including a prediction unit configured to predict a drop in a drive voltage of the thermal head before performing printing, based on data to be printed used to drive the thermal head, in which
the adjustment unit is configured to perform adjustment to bring the amount of heat generated by the plurality of heating elements closer to the defined value in a case where the prediction unit predicts a drop in the drive voltage of the thermal head.

### Supplementary Note 20

The program according to Supplementary Note 16, in which
the adjustment unit is configured to adjust the strobe time according to setting information in which a plurality of values of the drive voltage are associated with information about degrees of increase in the strobe time suitable for the plurality of values.

Any of the above-described apparatus, devices or units can be implemented as a hardware apparatus, such as a special-purpose circuit or device, or as a hardware/software combination, such as a processor executing a software program.

Further, as described above, any one of the above-described and other methods may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Each of the functions of the described embodiments, and any one of the above-described and other methods may be implemented by one or more processing circuits or circuitry. Processing circuitry includes a programmed processor, as a processor includes circuitry. A processing circuit includes devices such as an application specific integrated circuit (ASIC), digital signal processor (DSP), field programmable gate array (FPGA) and conventional circuit components arranged to perform the recited functions.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer apparatus configured to perform printing on a sheet-shaped medium with a thermal head including a plurality of heating elements, the apparatus comprising
an adjuster configured to perform adjustment to bring an amount of heat generated by the plurality of heating elements closer to a defined value in response to a drop in a drive voltage of the thermal head.

2. The printer apparatus according to claim 1, wherein
the adjuster is configured to perform adjustment to increase a strobe time defining an energization time for the plurality of heating elements to bring the amount of heat generated by the plurality of heating elements closer to the defined value.

3. The printer apparatus according to claim 1, wherein
the adjuster is configured to, in response to a drop in a drive voltage of a stepping motor configured to convey the medium, adjust a drive current of the stepping motor to be closer to a defined value.

4. The printer apparatus according to claim 3, wherein
the adjuster is configured to perform adjustment to increase a Vref value of a motor driver configured to control the stepping motor to bring the drive current of the stepping motor closer to the defined value.

5. The printer apparatus according to claim 1, further comprising a predictor configured to predict a drop in a drive voltage of the thermal head before performing printing, based on data to be printed used to drive the thermal head, wherein
the adjuster is configured to perform adjustment to bring the amount of heat generated by the plurality of heating elements closer to the defined value in a case where the predictor predicts a drop in the drive voltage of the thermal head.

6. The printer apparatus according to claim 2, wherein
the adjuster is configured to adjust the strobe time according to setting information in which a plurality of values of the drive voltage are associated with information about degrees of increase in the strobe time suitable for the plurality of values.

7. The printer apparatus according to claim 4, wherein
the adjuster is configured to adjust the Vref value according to setting information in which a plurality of values of the drive voltage and the Vref value suitable for the plurality of values are associated with each other.

8. A control method for a printer apparatus configured to perform printing on a sheet-shaped medium with a thermal head including a plurality of heating elements, the method comprising
performing adjustment to bring an amount of heat generated by the plurality of heating elements closer to a defined value in response to a drop in a drive voltage of the thermal head.

9. The control method according to claim 8, wherein
adjustment to increase a strobe time defining an energization time for the plurality of heating elements is performed to bring the amount of heat generated by the plurality of heating elements closer to the defined value.

10. The control method according to claim 8, wherein
in response to a drop in a drive voltage of a stepping motor configured to convey the medium, a drive current of the stepping motor is adjusted to be closer to a defined value.

11. The control method according to claim 10, wherein
adjustment to increase a Vref value of a motor driver configured to control the stepping motor is performed to bring the drive current of the stepping motor closer to the defined value.

12. The control method according to claim 8, further including predicting a drop in a drive voltage of the thermal head before performing printing, based on data to be printed used to drive the thermal head, wherein
adjustment to bring the amount of heat generated by the plurality of heating elements closer to the defined value is performed in a case where a drop in the drive voltage of the thermal head is predicted.

13. The control method according to claim 9, wherein
the strobe time is adjusted according to setting information in which a plurality of values of the drive voltage are associated with information about degrees of increase in the strobe time suitable for the plurality of values.

14. The control method according to claim 11, wherein
the Vref value is adjusted according to setting information in which a plurality of values of the drive voltage and the Vref value suitable for the plurality of values are associated with each other.

15. A non-transitory computer-readable medium including programmed instructions that cause a computer included in a printer apparatus configured to perform printing on a sheet-shaped medium with a thermal head including a plurality of heating elements, to function as
an adjuster configured to perform adjustment to bring an amount of heat generated by the plurality of heating elements closer to a defined value in response to a drop in a drive voltage of the thermal head.

16. The non-transitory computer-readable medium according to claim 15, wherein
the adjuster is configured to perform adjustment to increase a strobe time defining an energization time for the plurality of heating elements to bring the amount of heat generated by the plurality of heating elements closer to the defined value.

17. The non-transitory computer-readable medium according to claim 15, wherein
the adjuster is configured to, in response to a drop in a drive voltage of a stepping motor configured to convey the medium, adjust a drive current of the stepping motor to be closer to a defined value.

18. The non-transitory computer-readable medium according to claim 17, wherein
the adjuster is configured to perform adjustment to increase a Vref value of a motor driver configured to control the stepping motor to bring the drive current of the stepping motor closer to the defined value.

19. The non-transitory computer-readable medium according to claim 15, wherein the programmed instructions cause the computer to further function as a predictor configured to predict a drop in a drive voltage of the thermal head before performing printing, based on data to be printed used to drive the thermal head, and
the adjuster is configured to perform adjustment to bring the amount of heat generated by the plurality of heating elements closer to the defined value in a case where the predictor predicts a drop in the drive voltage of the thermal head.

20. The non-transitory computer-readable medium according to claim 16, wherein
the adjuster is configured to adjust the strobe time according to setting information in which a plurality of values of the drive voltage are associated with information about degrees of increase in the strobe time suitable for the plurality of values.
